(19) United States
(12) Patent Application Publication
(10) Pub. No.: US 2006/0224573 A1
(43) Pub. Date: Oct. 5, 2006

(54) Method and system to facilitate decision point information flow and to improve compliance with a given standardized vocabulary

(75) Inventors: Robert Daniel Claud, Chicago, IL (US); Erika Chiong-Claud, Chicago, IL (US); Sokol Marishta, Naperville, IL (US)

Correspondence Address: BANNER & WITCOFF, LTD., TEN SOUTH WACKER DRIVE, SUITE 3000, CHICAGO, IL, 60606, US

(73) Assignee: eCapable, Inc., Chicago, IL (US)

(21) Appl. No.: 11/361,764

(22) Filed: Feb. 24, 2006

Related U.S. Application Data
(63) Continuation-in-part of application No. 11/089,400, filed on Mar. 24, 2005.
(60) Provisional application No. 60/716,385, filed on Sep. 13, 2005.
(60) Provisional application No. 60/656,609, filed on Feb. 26, 2005.
(60) Provisional application No. 60/624,516, filed on Nov. 3, 2004.
(60) Provisional application No. 60/609,973, filed on Sep. 15, 2004.
(60) Provisional application No. 60/598,470, filed on Aug. 3, 2004.
(60) Provisional application No. 60/578,189, filed on Jun. 9, 2004.
(60) Provisional application No. 60/577,855, filed on Jun. 8, 2004.
(60) Provisional application No. 60/556,470, filed on Mar. 26, 2004.
(60) Provisional application No. 60/681,423, filed on May 16, 2005.

(51) Int. Cl. G06F 17/30; G06F 7/00

(52) U.S. Cl. 707/3

(57) ABSTRACT

An information search system incorporating computer algorithms that provide for (1) enforcement of compliance with a standardized vocabulary by a user or users, in a manner that is much more acceptable to users than known existing methods; 2) instant or essentially instant provision of information that is context sensitive, that is, sensitive to the sequence of characters that are entered by a user, in a manner that is highly acceptable to users.

This specification claims priority to U.S. Provisional Application Ser. Nos. 60/716,385, filed Mar. 26, 2005 and is a continuation in part of U.S. application Ser. No. 11/089,400, filed Mar. 24, 2005, which claims priority to the following U.S. Provisional Applications: Ser. Nos. 60/656,609, filed Feb. 26, 2005; 60/624,516, filed Nov. 3, 2004; 60/609,973, filed Sep. 15, 2004; 60/598,470, filed Aug. 3, 2004; 60/578,189, filed Jun. 9, 2004; 60/577,855, filed Jun. 8, 2004; 60/556,470, filed Mar. 26, 2004; and 60/681,423, filed May 16, 2005, all of which are incorporated by reference in their entirety herein.

### BACKGROUND OF THE INVENTION

### Description of Related Art

Internet browsers have had the ability to create a communications channel between a Client computer and a Central Server, via a Network, without a distinct directive action on the part of the user. The current invention involves techniques and methods that take advantage of these abilities.

Healthcare providers generally, and physicians specifically, have little tolerance for inefficient processes. They generally perceive that time is their most precious commodity. This explains the reluctance of many to embrace healthcare information technology that would otherwise have appeal—particularly with the promise of improved patient safety.

In general, current technology requires fully machine-interpretable data to be compliant with a given limited set of choices. The set of choices may be very limited (“Yes/No”) or extremely broad (one of a current list of medication names contains over 100,000 entries); however, the choices must be constrained to a limited set because of current technology limitations. Put plainly, a computer cannot interpret user entries with 100% accuracy when the number of possible entries is high; constraining user entries to a limited set of choices may address this issue.

At first glance, the solution to this problem may seem straight forward—force a user to choose from a list of possible options when entering data for storage and retrieval and create a rule set for the machine to use in interpreting responses thus entered. For situations with few choices, this may work. Computer users are almost universally willing to choose between two possibilities, and frequently between three or four. The current invention addresses a frequent situation in medicine—the range of possible choices runs to the tens of thousands. While rules can be created for the interpretation of each of these possible choices, the data entered must be compliant with data-entry rules in order for the computer to interpret the data and apply the rules.

### SUMMARY OF THE INVENTION

The inventive system is particularly applicable to the demands of healthcare providers and physicians, by providing fast and efficient user interface design, particularly when the user is required to create machine interpretable data.

Aspects of the present invention relates generally to the field of information storage and retrieval, and more particularly to the field of electronic medical records, specifically a system that enables the creation, storage, and retrieval of digital medical information that present day computers can both retrieve and interpret. The invention thus relates to the creation of machine-interpretable medical information for storage and later retrieval, using methods that are user-friendly, intuitive, and palatable to physicians and other healthcare providers relative to other known systems.

Aspects of the current invention builds on the accomplishment of the first principal aspect: the system, which is used to create data that is machine interpretable, is able, as a second principal aspect, to provide context-sensitive information to the computer user that is based on the application of computer-based rules used to interpret the information entered, in a manner that is more user-friendly, as well as intuitive and palatable to physicians and other healthcare providers than current systems.

The inventive methods and system accomplish this in a manner that is quicker, more user-friendly and intuitive than any other current known systems. This addresses the usability issue that has, to date, been a major impediment to physician adoption of healthcare information technology systems and thus holds a potential of improved patient safety and care.

Briefly, the present invention provides solutions to the problems outlined above. It facilitates the creation and maintenance of data that is machine interpretable and therefore amenable to computer algorithms. Simultaneously, it accomplishes informing the computer user of the results of computer algorithms which have been applied to the data entered by the user in an instantaneous, or nearly instantaneous, manner.

The present invention draws on the ability of a computer algorithm, resident and running on a server computer which is connected to a client computer via a network, to interpret user entries in a browser window in real time and to display context-sensitive data in response to said user entries in the browser window. This server runs an application which interprets user entries in real time and applies algorithms to the data entered by the user. Where appropriate, the server displays the results of these algorithms to the user.

A first aspect of the present invention which is especially applicable to drug lists and information and involves constraining user entries to a pre-defined vocabulary of possible choices. This accomplished by displaying, in real time, a list of the available possibilities from within a pre-defined vocabulary in response to the user's individual key-strokes.

A second aspect of the present invention involves the display of context-sensitive information to the user, in real time and in response to user entries—entries which may be defined to a level of granularity of a keystroke.

A third aspect of the present invention involves the display of information specifically pertaining to adverse drug interactions, in real time, occurring prior to the actual prescription of a drug by a physician.

A fourth aspect of the present invention involves the display of information specifically pertaining to checking of drug dose information entered by a user against an predefined set of dosing rules specific to a drug.

A fifth aspect of the present invention involves the display of information specifically pertaining to an appropriate route of administration for a given drug, or a given drug/dose combination.

A sixth aspect of the present invention involves the display of information specifically pertaining to drug-allergy interactions.

A seventh aspect of the present invention involves the display of information specifically pertaining to drug-condition interactions, where condition refers to a medical condition, disease, or disability.

An eighth aspect of the present invention involves the display of information specifically pertaining to drug-food interactions.

A ninth aspect of the present invention involves the display of a static data set of information that is specific to a respective drug.

A tenth aspect of the present invention involves the display of a static data set to the user, in response to user input that is user sensitive. This is accomplished by incorporating an identity management algorithm into the algorithm that selects the appropriate Static Data Set, with respect to the user, from which to supply context and user sensitive data to the user.

An eleventh aspect of the present invention involves the display of a static data set to the user, in response to user input that is patient sensitive. This is accomplished by incorporating an identity management algorithm into the algorithm that selects the appropriate Static Data Set, with respect to the particular patient, from which to supply context and user sensitive data to the user.

A twelfth aspect of the present invention involves the display of a static data set to the user, in response to user input that is patient sensitive. This is accomplished by incorporating an identity management algorithm into the algorithm that selects the appropriate Static Data Set, with respect to both the user and the patient, from which to supply context and user sensitive data to the user.

A thirteenth aspect of the present invention is to provide a means of storing and retrieving, in a means that is more user friendly than known previous methods, a user's previous responses to the identical Text Entry Interface, by such a means that the user can then select the appropriate response that he desires from a list of his previous responses. This is also accomplished with an identity management algorithm incorporated into the system.

A fourteenth aspect of the present invention is to allow users to enter data that is compliant with a standardized vocabulary, even if they are relatively uninformed about what the standardized vocabulary contains. For example, by means of displaying information that contains internal character sequences—disregarding the initial characters or characters entered by the user—the system could allow a user to select a choice that he was looking for even without knowing how to spell the word or phrase.

A fifteenth aspect of the present invention is a natural migration pathway from “dirty data” to “clean data”, as described above. By comparing previous entries to those contained within a standardized list of acceptable entries, the entries that do not comply with the standardized list can be presented to the user for clarification and the Text Entry Interface incorporated into the system for the user to enter the clarification can incorporate the system as described herein; by this means, the “dirty data” can be eliminated from a database and replaced by “clean data” in an extremely logical and practical way.

A sixteenth aspect of the present invention, in the medical field, is to facilitate research. Any database containing data that is not machine interpretable is much more difficult to conduct research on, whereas any database containing machine interpretable data is much more conductive to research, particularly drug related research.

A seventeenth aspect of the current invention is a means of displaying cost data for tests, procedures, or drugs, at the time a physician or other healthcare provider is deciding to order such tests, procedures, or drugs.

An eighteenth aspect of the current invention is a means of providing clean data, in the form of a list of the medications a patient is currently taking, to an algorithm that checks the list of medications for adverse drug interactions.

A nineteenth aspect of the current invention is to help the user bidirectionally convey information electronically and remotely with another healthcare information technology system. Clean data enables and facilitates this; dirty data does not.

A twentieth aspect of the present invention involves the display of a static data set of information that is specific to a medical disease or condition.

These and other objects, advantages, features, and aspects of the invention are set forth in the detailed description which follows.

### DETAILED DESCRIPTION OF THE DRAWINGS

In the detailed description which follows, reference will be made to the drawing comprised of the following figures:

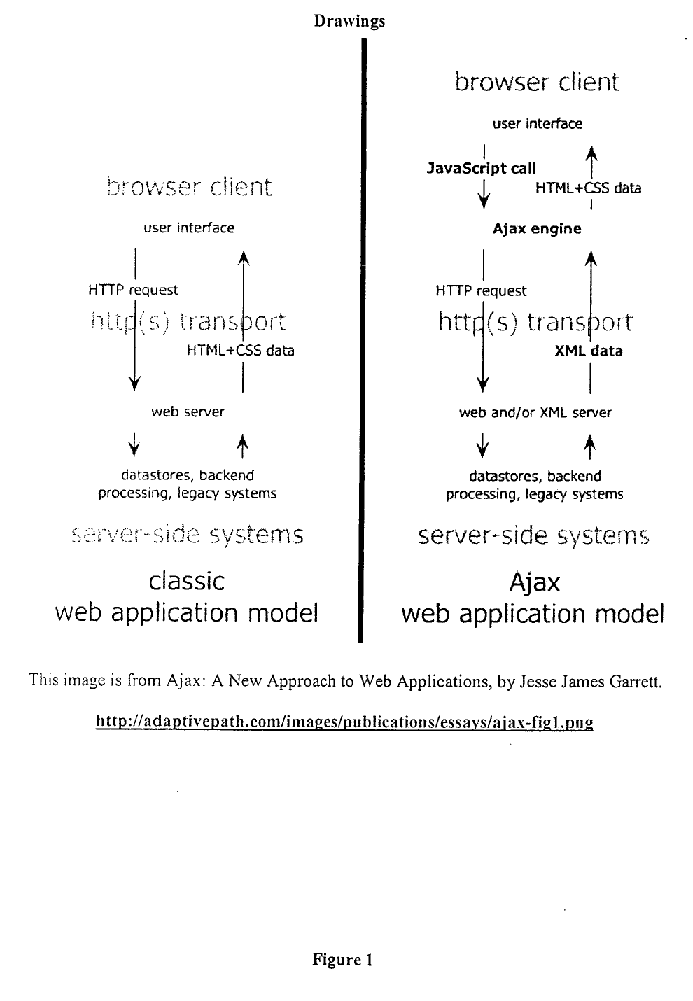

FIG. 1 is a visual representation of the traditional model of web applications and the Ajax web application model.

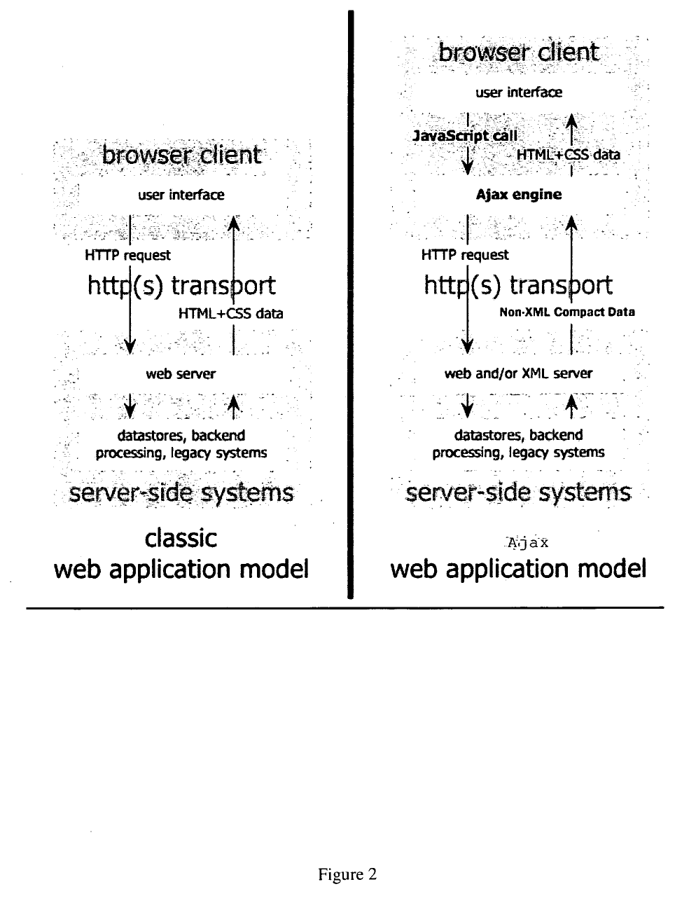

FIG. 2 is a visual representation of the web application model of the current invention.

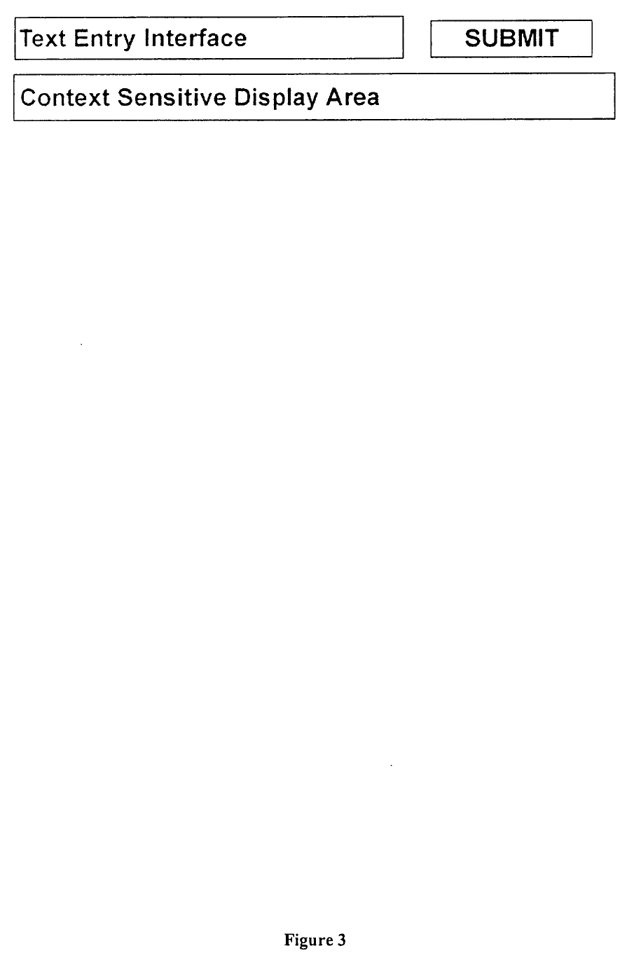

FIG. 3 is a visual representation of three distinct visual areas defined according to the current invention.

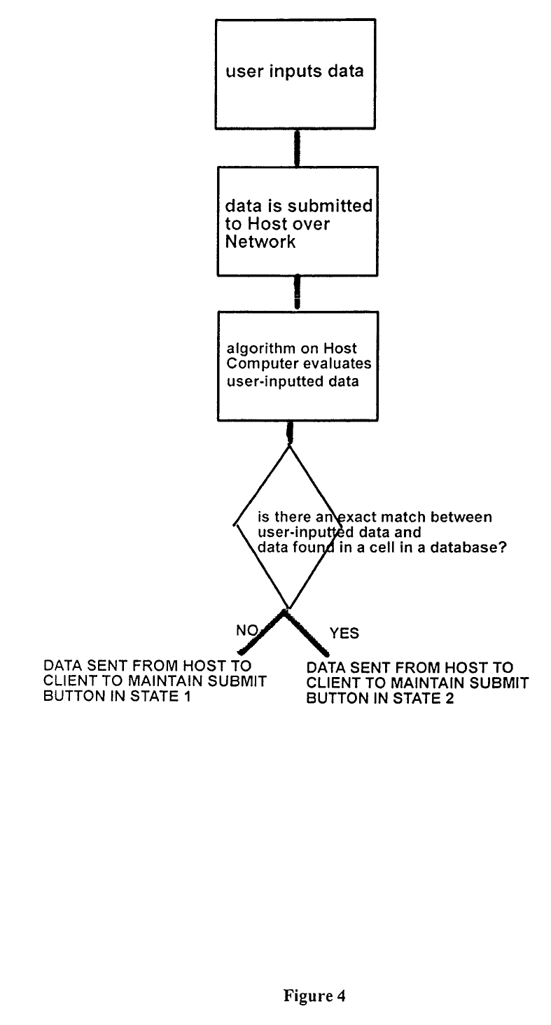

FIG. 4 is a visual representation of the information flow according to one embodiment of the current invention.

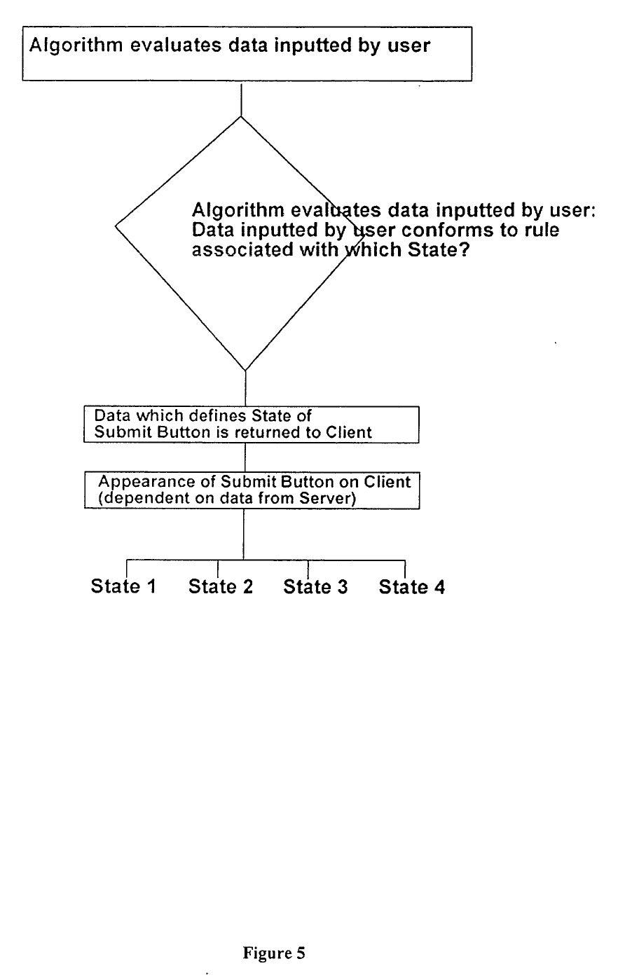

FIG. 5 is a visual representation of the information flow according to another embodiment of the current invention.

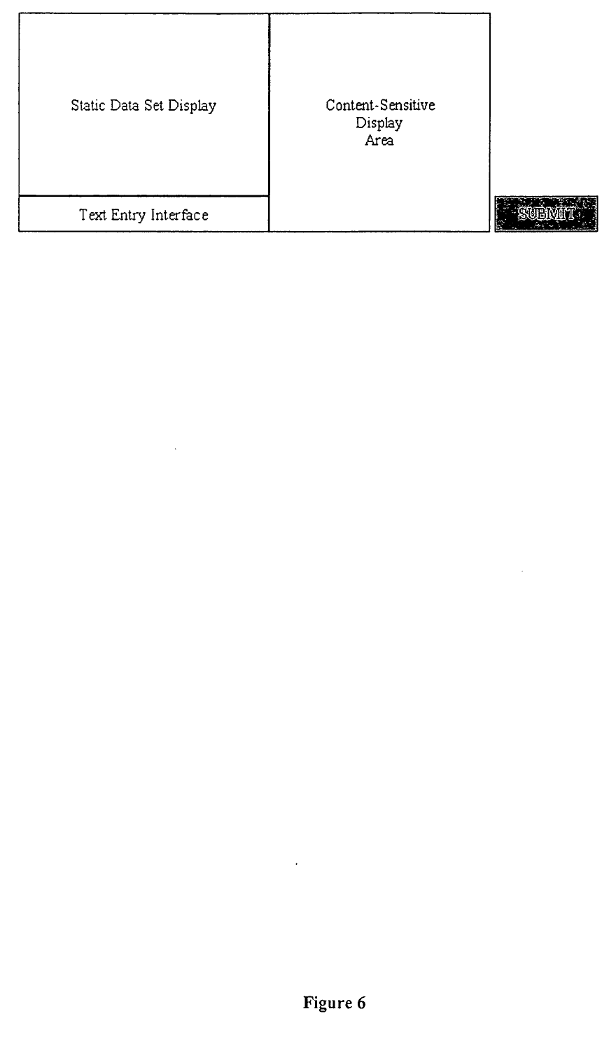

FIG. 6 is a visual representation of a slightly different user interface approach, according to the current invention.

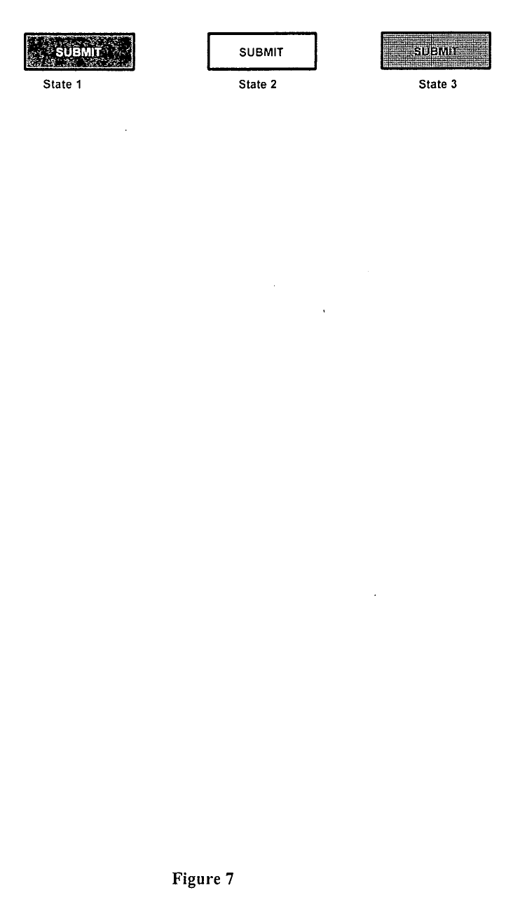

FIG. 7 is a visual representation of three different visual appearances of the “Submit” button, according to the current invention.

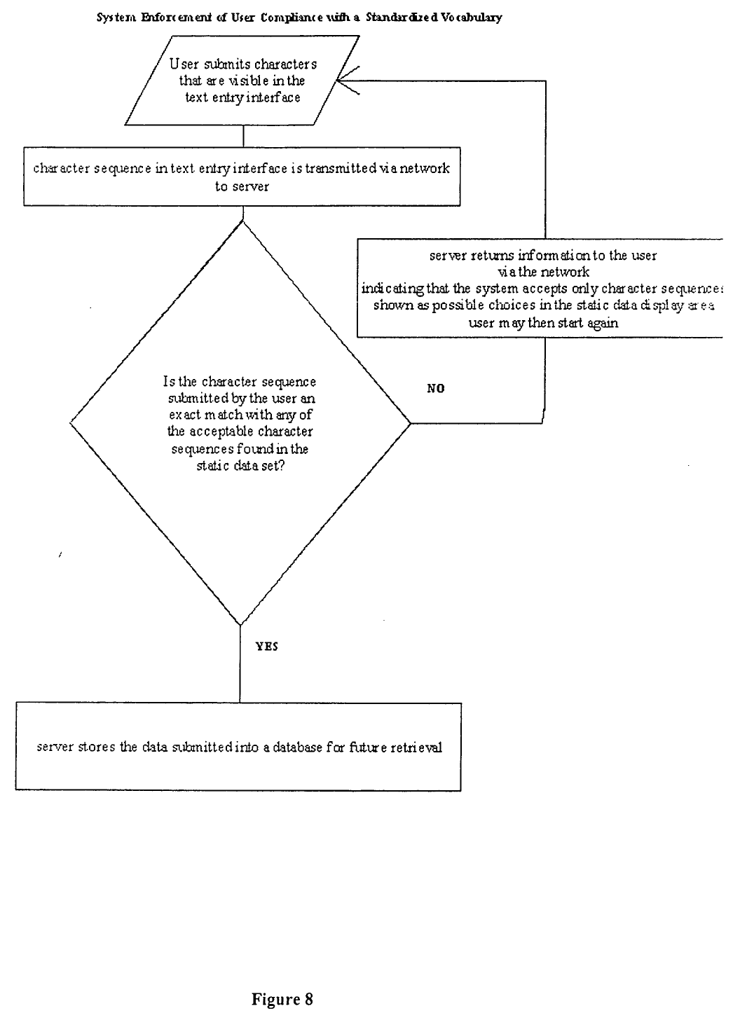

FIG. 8 is a visual representation of the information algorithm used, according to the current invention, to provide the user with real-time context-sensitive feedback on the fit between what the action of the user (e.g. a mouse click or a keystroke) and what the inventive system will accept as a valid entry.

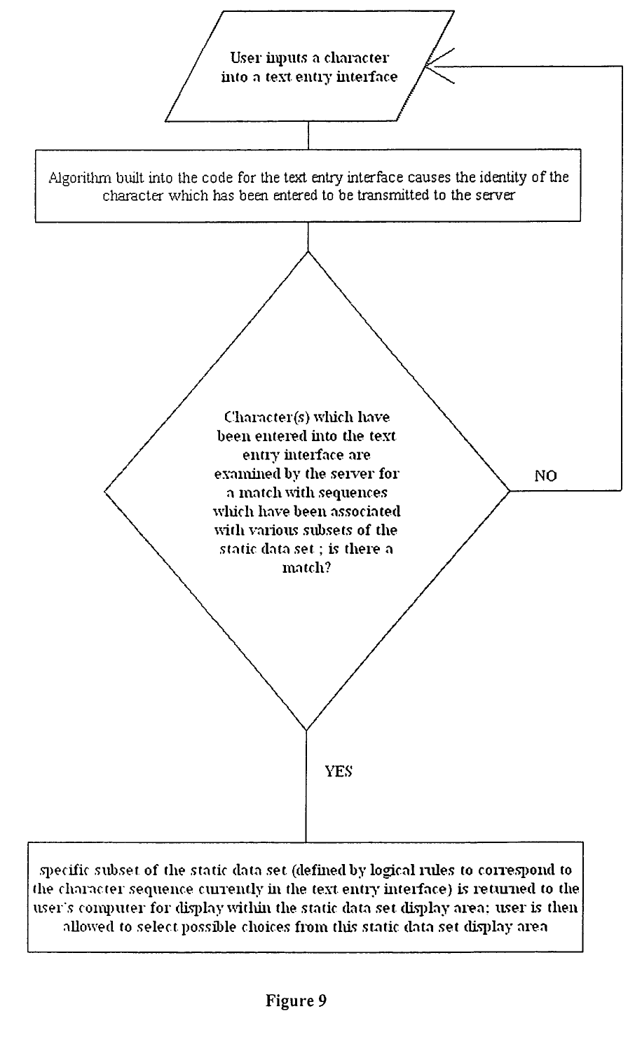

FIG. 9 is a visual representation of the information algorithm used, according to the current invention, to provide the user with real-time context-sensitive feedback on the fit between action of the user (e.g. a mouse click or a keystroke) and what the inventive system will accept as data to be submitted to the database for future retrieval.

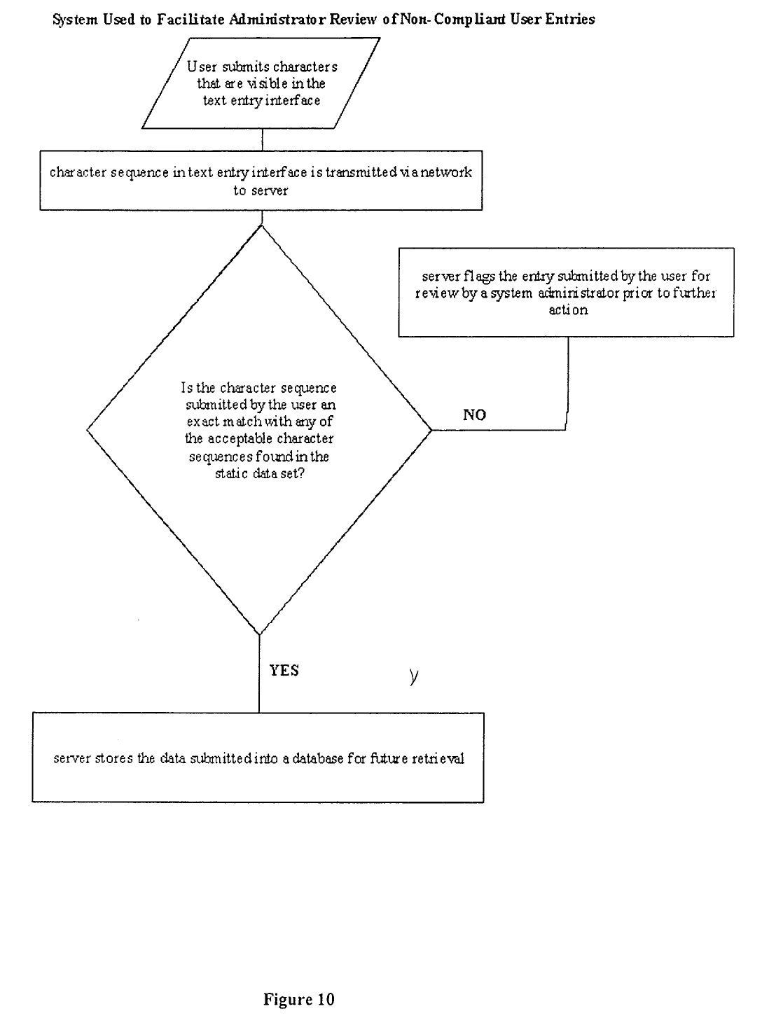

FIG. 10 is a visual representation of the algorithm used, according to the current invention, to provide the user with real-time context-sensitive choices from a pre-defined static data set in response to action of the user (e.g. a mouse click or a keystroke).

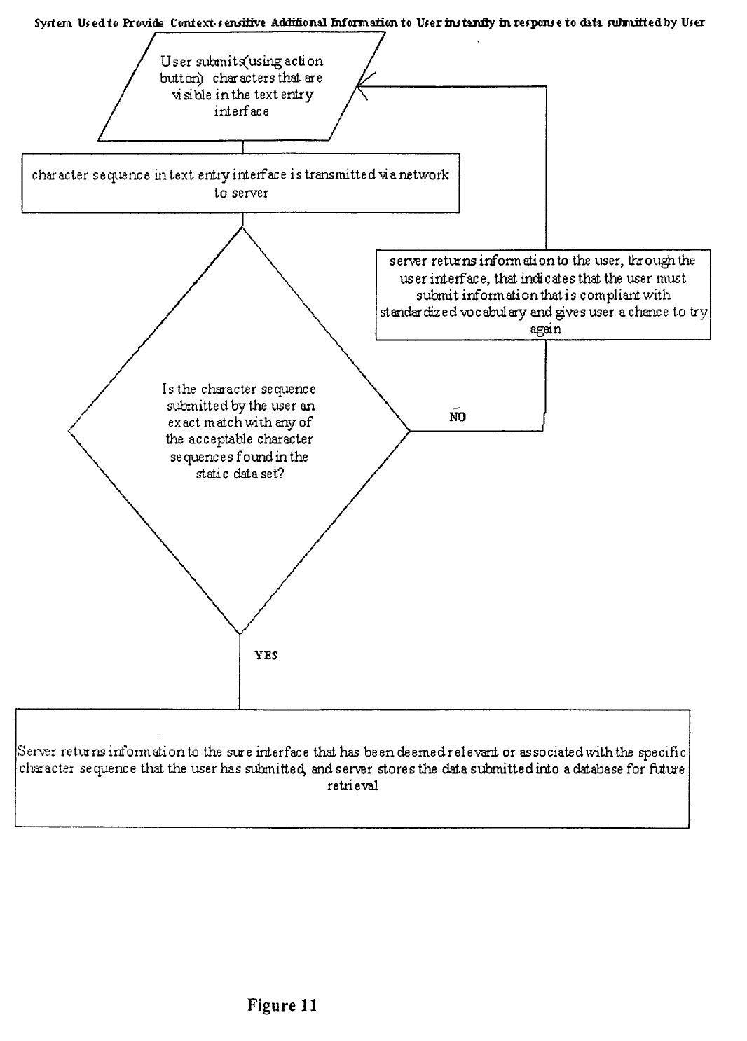

FIG. 11 is a visual representation of the algorithm used, according to the current invention, to flag entries which are non-compliant with a static data set of acceptable entries for future review.

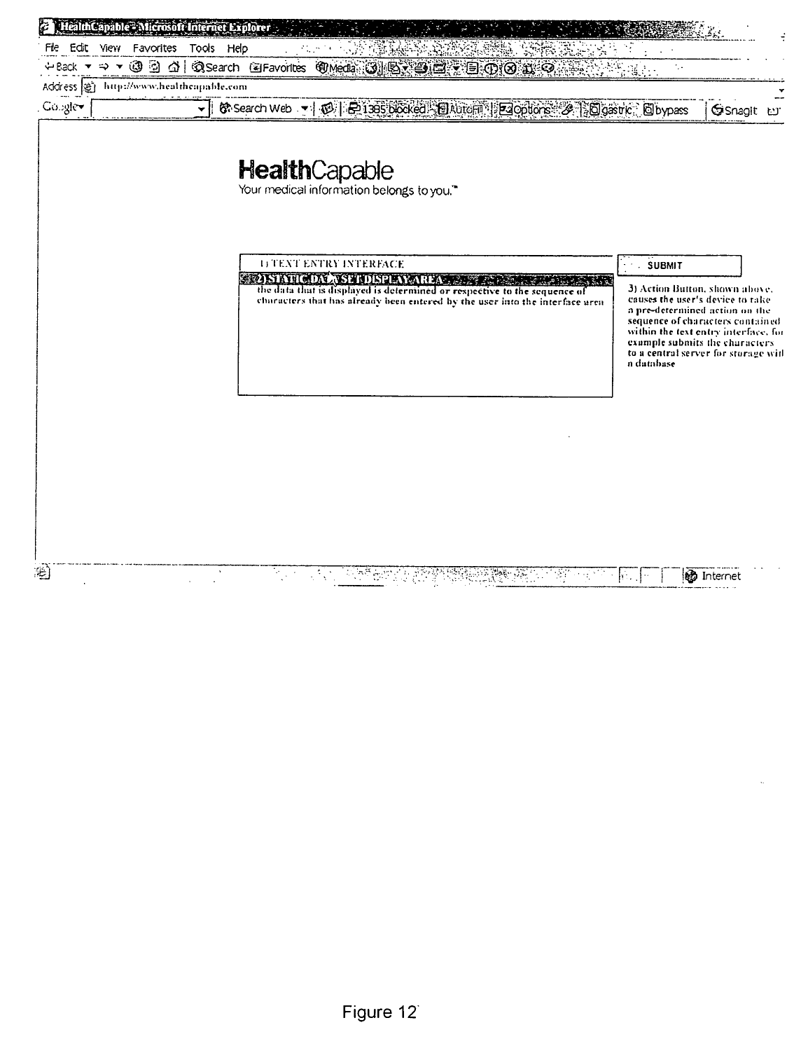

FIG. 12 is representative of an information flow rule set for one embodiment of the current invention.

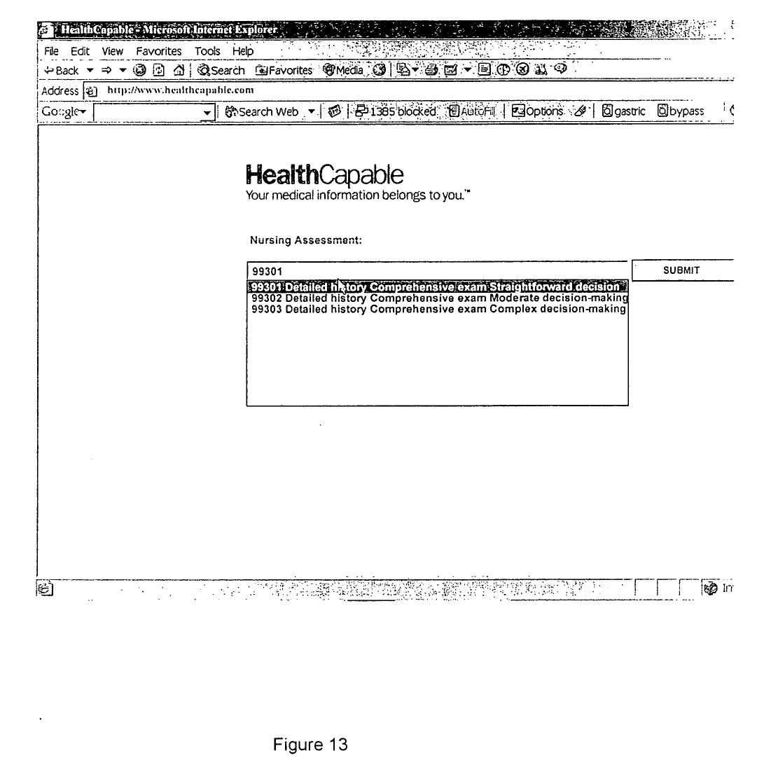

FIG. 13 is representative of a screen-shot showing discrete areas of the user interface according to one embodiment of the current invention.

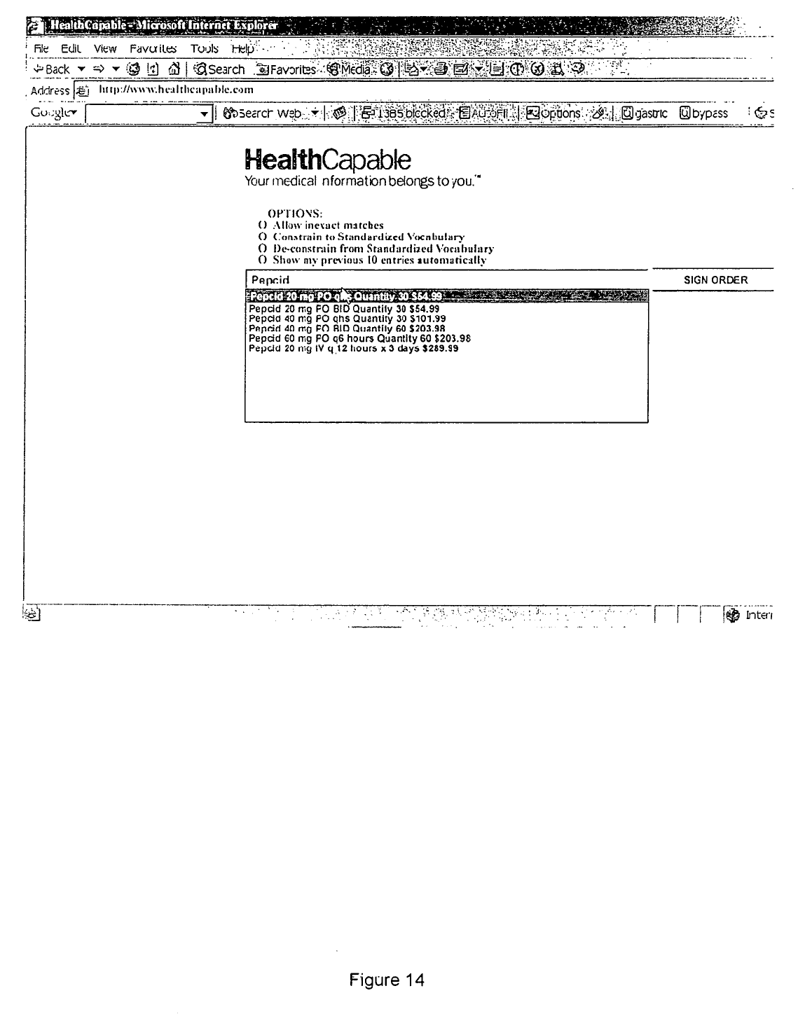

FIG. 14 is representative of a screen-shot showing one possible representation of the user interface according to one embodiment of the current invention.

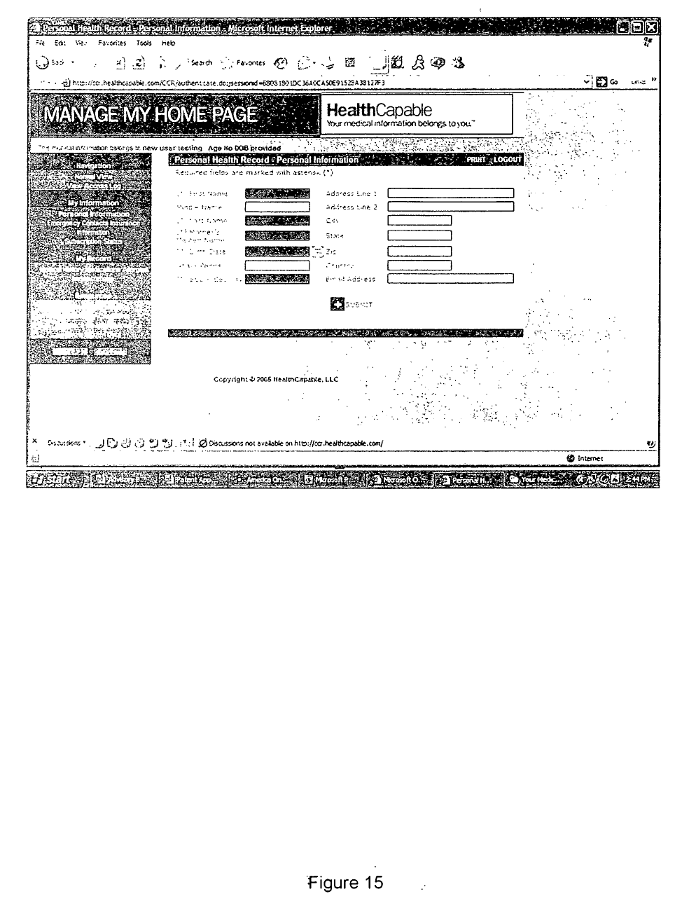

FIG. 15 is representative of a screen-shot showing discrete areas of the user interface according to one embodiment of the current invention, along with some possible system/algorithm options definable by either user or system administrator.

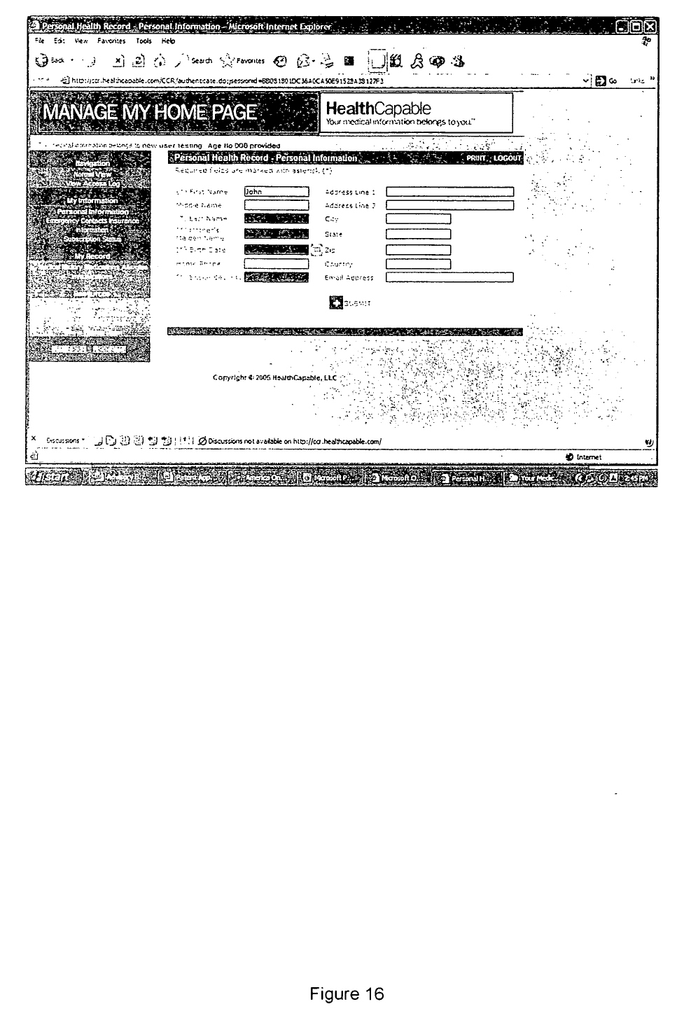

FIGS. 16-32 are a series of screen-shots taken for one embodiment of the current invention.

### DESCRIPTION OF THE PREFERRED EMBODIMENT

In the following description, various terms will be utilized in their normal sense and context and will include the following additional features with respect thereto.

“User” will mean an individual user, patient, a physician, a guardian, an institution any entity which desires to store and retrieve medical information.

“Screen” means the visual presentation at a terminal setting forth and representing information visually to the user. The screen may include tool bars and other information, instructions, and the like which will facilitate the use of the information provided to or by the user as well as interactions by or for the user through the terminal to a server.

“Network” means any means of electronic data transfer communication between servers, terminals, and hardware including the world wide web, wireless and wired internal dedicated networks and external networks.

Overview of the System and Vocabulary Method

FIG. 1 contrasts the classic web application model (on the left) with the component parts used by the current invention (on the right). Briefly, a browser client computer displays a user interface; the user interface displays information according to an Ajax engine as referenced. The Ajax engine comprises computer codes that define algorithms used to define what is displayed at the user interface and what information is transferred from the browser client to the server-side systems. The server-side systems contain static data sets (datastores), algorithms, and inputs from other data sources, as well as an application that interact with these various sources of data.

FIG. 2 is illustrative of a preferred embodiment of the current invention using the Ajax software in contrast to classic software.

One preferred embodiment of the current invention is used to enforce user data entry compliance with a given set of choices contained within a static data set. FIGS. 3, 4, and 5 illustrate principles associated with this embodiment. In FIG. 3, representations of three discrete visual display areas associated with the user interface are represented. The text entry interface represents an area of the display that displays letters typed by the user. The Context Sensitive Display Area is a display area that displays information/data that is sent from the server to the browser client in response to user actions, in this case, typing while the cursor is in the text entry interface. In this preferred embodiment, the Context Sensitive Display Area is used to display possible choices that a computerized algorithm finds to be related to the user input. The Submit button, also shown, represents a visual display area that a user can click on to direct information to be processed by the server. In a preferred embodiment of the current invention, the Submit button also displays context-sensitive information, by changing its appearance, or state, in real time, in response to the user's typed entries in the text entry interface.

In an embodiment of the current invention, the algorithm flow diagram shown in FIG. 4 illustrates the process by which the state of the Submit button can be defined, in real time, according to user input. “Host” and “Host Computer” in this figure are used to represent “Server-side systems.” No distinct directive action on the past of the user is required for the server to process the user input, according to the algorithm found on the server, and return data to the client browser.

The FIG. 5 flow diagram illustrates a slightly more complex embodiment of the current invention, which allows the Submit Button to convey information based on four different states in response to user input.

Systems used to enforce user compliance with a predefined vocabulary set may wish to provide the user with real-time feedback on the user choices which have already been made via user input. Using the representation of a user interface shown in FIG. 6, a Context-Sensitive Display Area may be used to display information, stored and retrieved from a server-side system, which is relevant to the information selected from the user and from a static data set display (or typed by the user into a text entry interface). This data may be different from the information shown in the static data set display.

For example, the user can type the first few letters of a drug name in the text entry interface, select (by mouse click for example) the complete name of a drug from the state data set display, and then, again without further directive action on the part of the user, data relevant to the drug selected is displayed in the Content-Sensitive Display Area.

This entire process can be further facilitated or enabled by displaying real-time feedback to the user, based on user actions, in response to user input. The flow diagram of FIG. 7 is illustrative of this principle—displaying that the appearance of the submit button can change to different states in response to user input. For example, State 1 could represent a drug that was not on a given medication formulary, State 2 could represent a drug that was on a given formulary, and State 3 could represent a drug that was on a formulary but required a copay.

Another preferred embodiment for the current invention that illustrates the use of different States illustrated by FIG. 7 is the likelihood of a significant drug interaction between the medication selected by the user using the text entry interface and a given list of drugs. While FIG. 7 shows three possible states, infinite possible states are envisioned, representing a spectrum of possibilities ranging from high likelihood to no likelihood.

A preferred embodiment of the system may require the user to store (in a database) only data that is found in a static data set—that is, user entries must be consistent with a standardized vocabulary. FIG. 8 illustrates, by flow diagram, an algorithm to convey information to the user, in real time and without distinct directive action on the part of the user, feedback that helps accomplish user compliance with the standardized vocabulary. In this embodiment of the invention, as soon as the algorithm determines that the characters found in the text entry interface corresponds with an entry in the static data set (standardized vocabulary), the server immediately stores that entry for future retrieval—without additional distinct directive action on the part of the user.

FIG. 9 is a flow diagram further illustrating an algorithm embodiment of the current invention. This algorithm is used to illustrate the flow of information between user, server, and browser-client. In this illustration, algorithms are used to define choices contained within the standardized vocabulary which are likely to be matches with what the user intends to enter. These choices are then displayed in the static data set display area for user selection.

FIG. 10 is a flow diagram representative of another preferred embodiment of the inventive system. The system can be designed in such a way that data entries which are non-compliant with a static data set, or with an algorithm that defines acceptable user inputs, are flagged for automatic subsequent review, while data entries which are compliant with a static data set or with such an algorithm are stored automatically for future retrieval.

FIG. 11 is a flow diagram illustrative of another preferred embodiment of the current invention. This method of information flow and algorithm is used, for example, to display drug dosing information for a given drug name; and enforces user compliance with a list of accepted drug names (the standardized vocabulary).

Table I is illustrative of a rule set that is used to define various states and functionalities of a submit button, in response to user input. These states are used to indicate information to the user based on user input—e.g. keystroke—without additional distinct directive action on the part of the user.

TABLE I

| | | Contents of | |
|---|---|---|---|
| | Appearance | Context Sensitive | Functionality of |
| State | On Screen | Display Area (CSD) | Submit Button |
| State 1 | Red | Initial state: data | On click = display |
| | | returned from Server | data returned from |
| | | On Submit Button | Server within CSD |
| | | Click: data returned | |
| | | from CSD | |
| State 2 | Green | Initial state: none | On click = post |
| | | On Submit Button | data contained in |
| | | Click: none | text entry inter- |
| | | | face(s) to Server |
| State 3 | Gray | None | None |
| State 4 | Yellow | Initial state: none | On click = post |
| | | On Submit Button click = | data in text entry |
| | | display data returned | interface to Server |
| | | from Server in Context- | On hover = display |
| | | Sensitive Display Area | data returned from |
| | | On Submit Button hover = | Server in Context- |
| | | display data returned | Sensitive Display |
| | | from Server in Context- | Area |
| | | Sensitive Display Area | |

A real-life possible application of the system described in Table I is illustrated in Table II, representing another possible preferred embodiment. This illustration is used to help explain the various functionalities of the Submit Button in response to user input and evaluation of such input by the sever-side system.

TABLE II

| | | Contents of | |
|---|---|---|---|
| | | Context Sensitive | Functionality of |
| State | Appearance | Display Area (CSD) | Submit Button |
| State 1 | Red | Initial state: data | On click = display |
| | | returned from Server | data returned from |
| | | On Submit Button | Server within CSD |
| | | Click: data returned | |
| | | from CSD | |
| State 2 | Green | Initial state: none | On click = post |
| | | On Submit Button | data contained in |
| | | Click: none | text entry inter- |
| | | | face(s) to Server |
| State 3 | Gray | None | None |
| State 4 | Yellow | Initial state: none | On click = post |
| | | On Submit Button click = | data in text entry |
| | | display data returned | interface to Server |
| | | from Server in Context- | On hover = display |
| | | Sensitive Display Area | data returned from |
| | | On Submit Button hover = | Server in Context- |
| | | display data returned | Sensitive Display |
| | | from Server in Context- | Area |
| | | Sensitive Display Area | |

An image representative of a screen shot displaying the relevant user interface areas is shown in FIG. 12. This image displays, in a screen shot format, the text entry interface, the static data set display area, and the submit button. The submit button constitutes a distinct directive action on the part of the user, causing user inputs to be evaluated by the server.

FIG. 13 is representative of a screen shot displaying data entered by the user in the text entry interface (“99301”) and data returned by the server side system in response to the 99301 that was submitted by the client to the server. In this case the static data set is a more complete description of codes which may be inputted by the user—after entering the code, the user see additional information that relates to the code (other possible common choices, and descriptive language about the choices)—and the user is expected to select a choice from the static data set prior to clicking on the submit button.

Illustrative of some of the system options possible according to the current invention, FIG. 14 displays some of the possible options as user choices. For example, were the user to select “Allow inexact matches,” the system could be designed to display information based on close matches to the character sequence entered by the user, not just exact matches. Were the user to select “De-constrain from Standardized Vocabulary,” the system would then allow the submission of user entries that were not compliant with the standardized vocabulary. If the user selected “Show my previous 10 entries automatically,” the static data set display area could be used to automatically display the user's previous 10 entries in this same text entry interface. Finally, what is referred to as the Submit button is displayed, in this illustration, as “Sign Order” to indicate that, in conjunction with an identity management system, the inventive system could be used to properly validate, confirm, and transmit an electronic prescription to a pharmacist.

Examples of the System

Screenshots of a preferred embodiment of the current invention are shown in FIGS. 15-32. In this embodiment, the text entry interface has various states, and the submit button has only one state. Context-sensitive feedback, based on user input, is displayed by changing the state (in this case, the color) of the text entry interface.

In this embodiment, user entry fields which are required for proper use of the system are displayed along with optional fields. The text entry interfaces for required fields have a red background initially; the background color changes in response to user data entry in the text entry interface.

In FIG. 15, representative of a user registration system, the first name, last name, mother's maiden name, and social security number are shown with a red background—indicating that they are required entries for proper system use.

FIG. 16 is a screen shot of this preferred embodiment of the system; it shows the appearance of the user interface after the user has input “John” in the first name field. No additional distinct direction action on the part of the user is required for the client browser to determine, based on an algorithm which is at the server side system, that the entry John is allowed—and the background color of the first name field changes from red to blue.

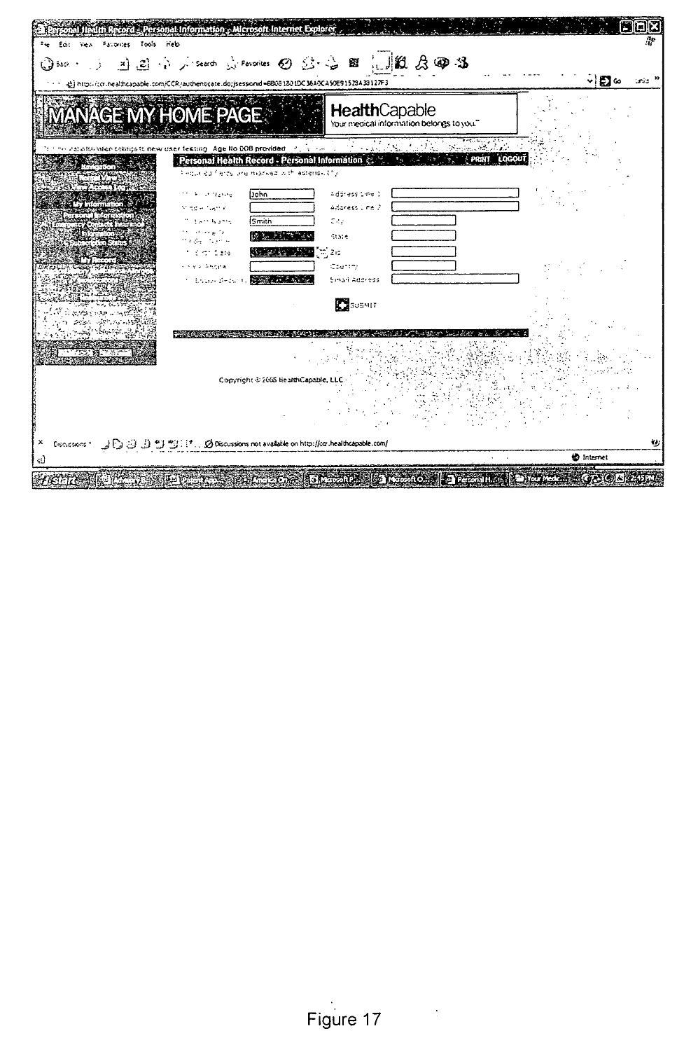

FIG. 17 illustrates further user progress through the user registration system; in this figure the user has typed “Smith” in the last name field. No additional distinct directive action on the part of the user is required for server side systems to evaluate the typed input of the user according to predetermined algorithms.

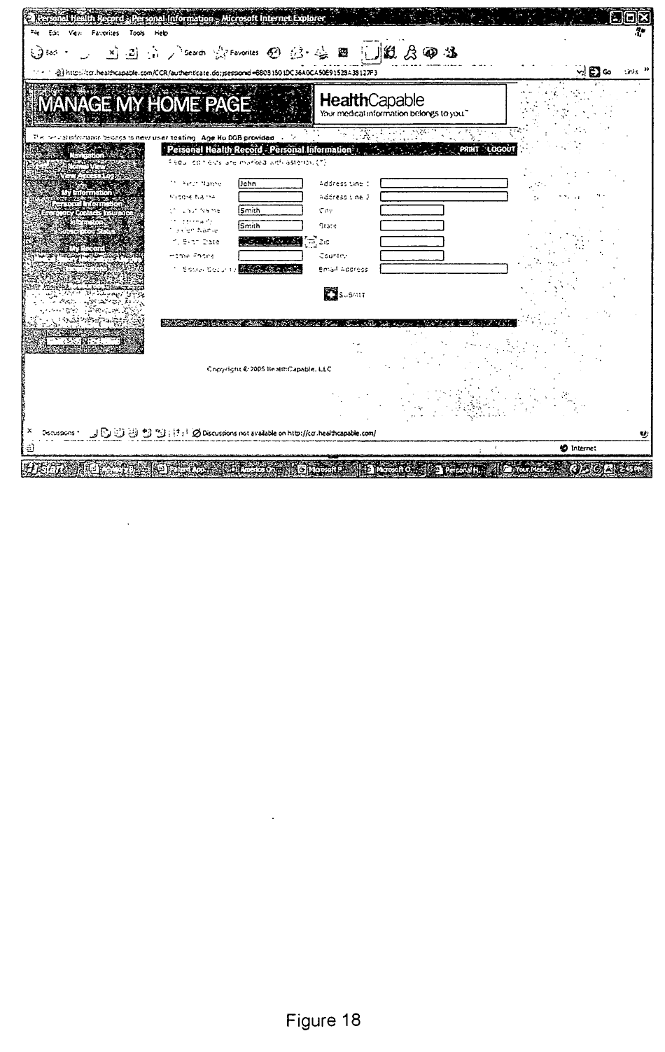

FIG. 18 shows further progress through the representative embodiment of the inventive system. The user has typed “Smith” in the Mother's Maiden Name” field.

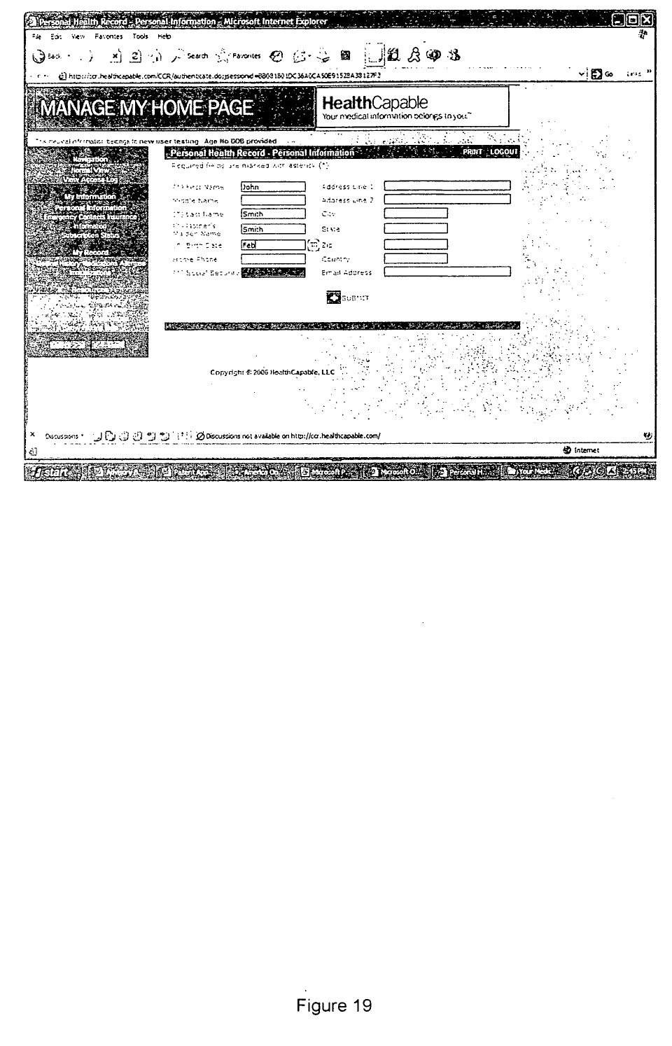

The ability of the various states of the text entry interface to convey useful information to the user is illustrated in FIG. 19—the background of the Birth Date text entry interface has turned yellow in response to the user typing “Feb” (without further distinct directive action on the part of the user)—the server-side algorithm is evaluating the characters entered by the user to determine if they fit a pre-defined set of rules (in this case, that only numbers and slashes are used to represent a date).

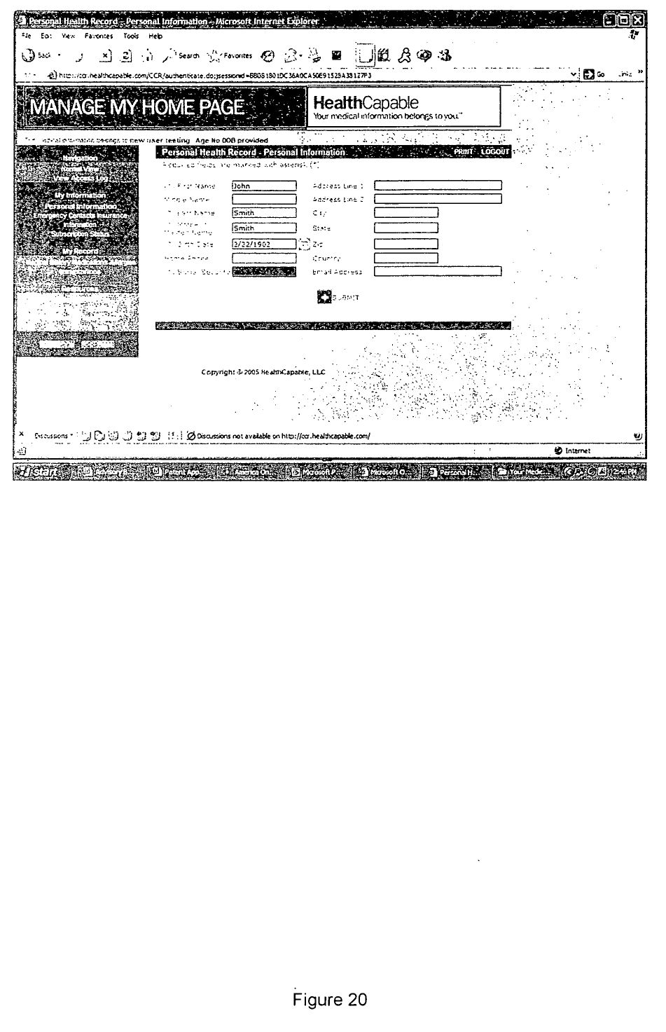

FIG. 20 shows further user progression through this embodiment of the current invention; the user has not entered birth date in a manner that the server-side algorithms determine to be acceptable. The red background color of the Social Security field shows that it remains as a required field.

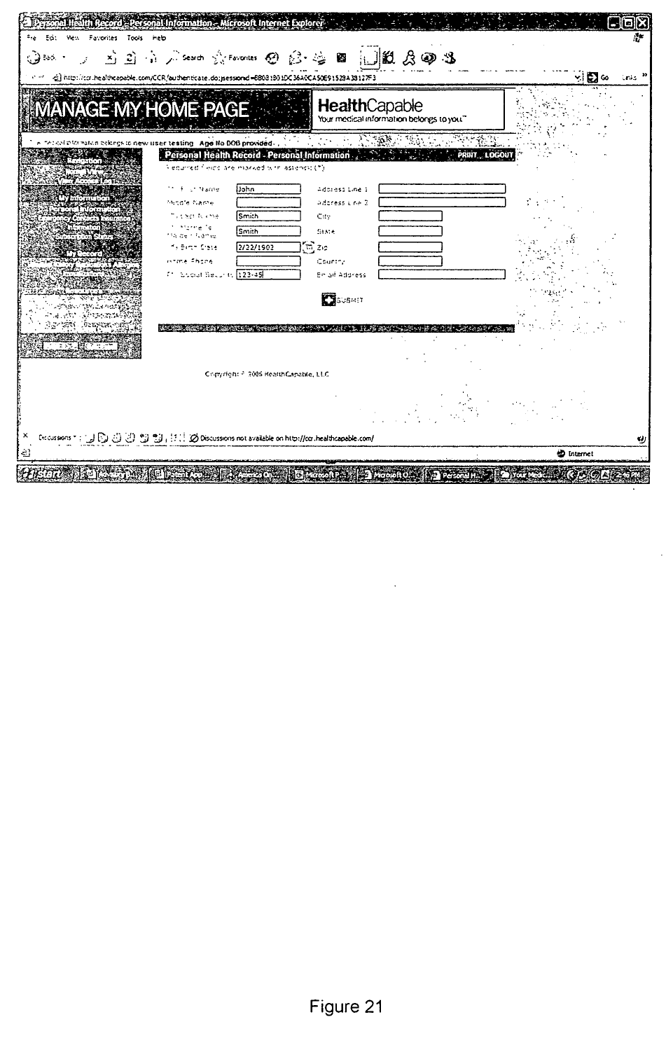

FIG. 21 again shows this embodiment of the invention at work—the algorithm displays the background color of the text entry interface (yellow) showing that the server is evaluating the user input.

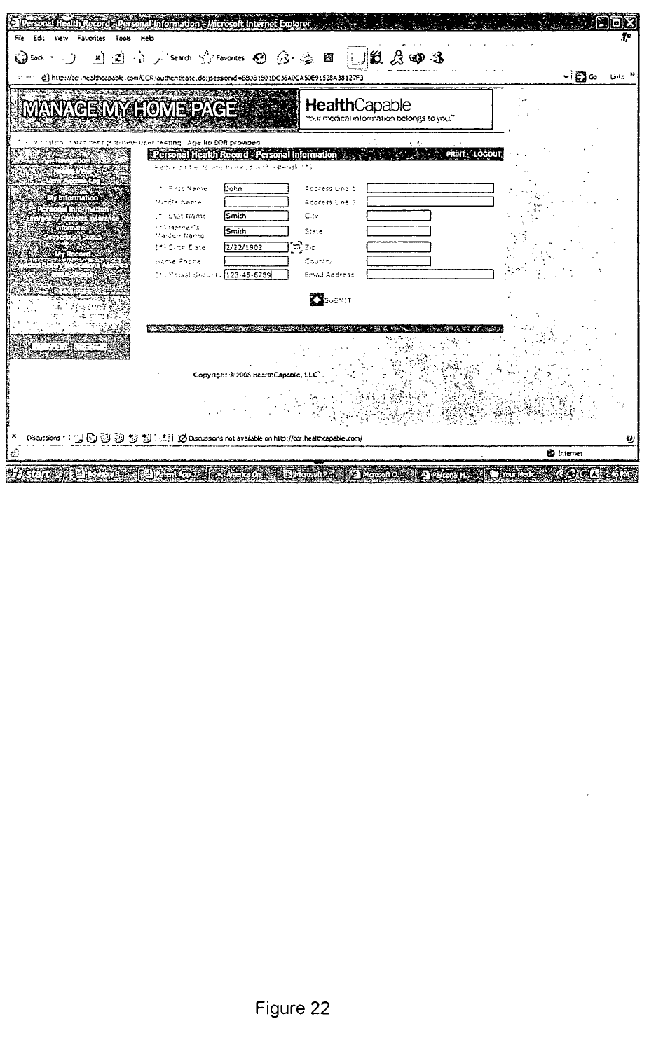

FIG. 22 shows the appearance of the user registration system, according to the current invention, after evaluation of the user input by the server side systems. In this case the server side systems cause the browser client to display all text entry interfaces with a blue background to convey that all required fields are acceptable and ready for submission. The user can then, via a distinct directive action (clicking on the submit button or pressing the enter key) cause the data shown in the text entry interfaces to be transmitted to the server for further evaluation/storage and future retrieval.

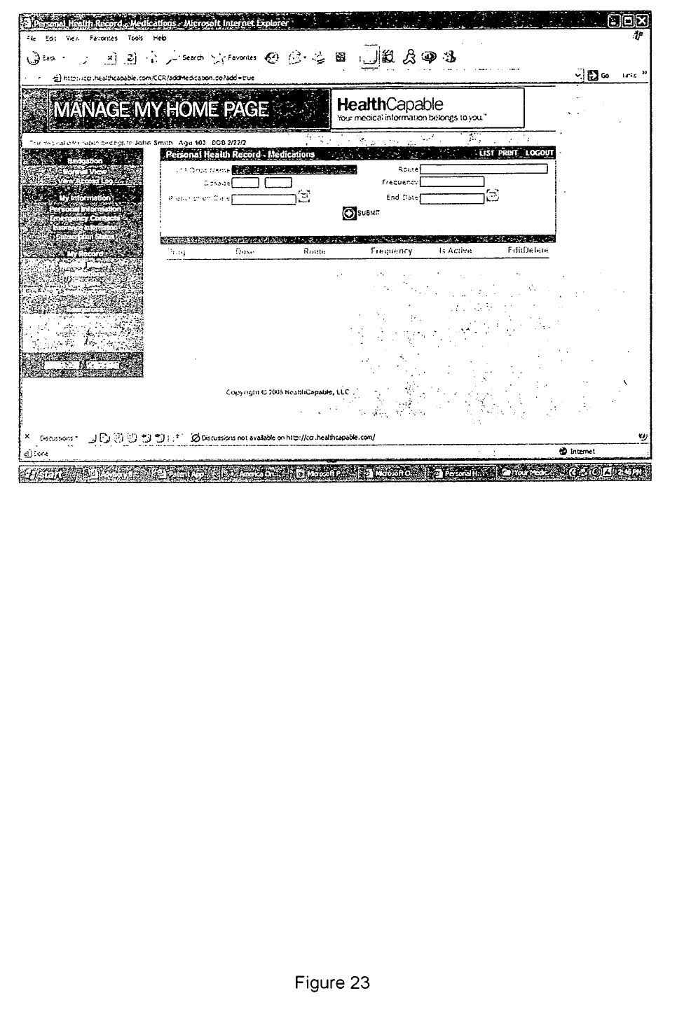

According to this preferred embodiment of the current invention, the Drug Name is a required field in the user interface displayed in FIG. 23. Prior to user input, the Drug Name text entry interface is displayed with a red background.

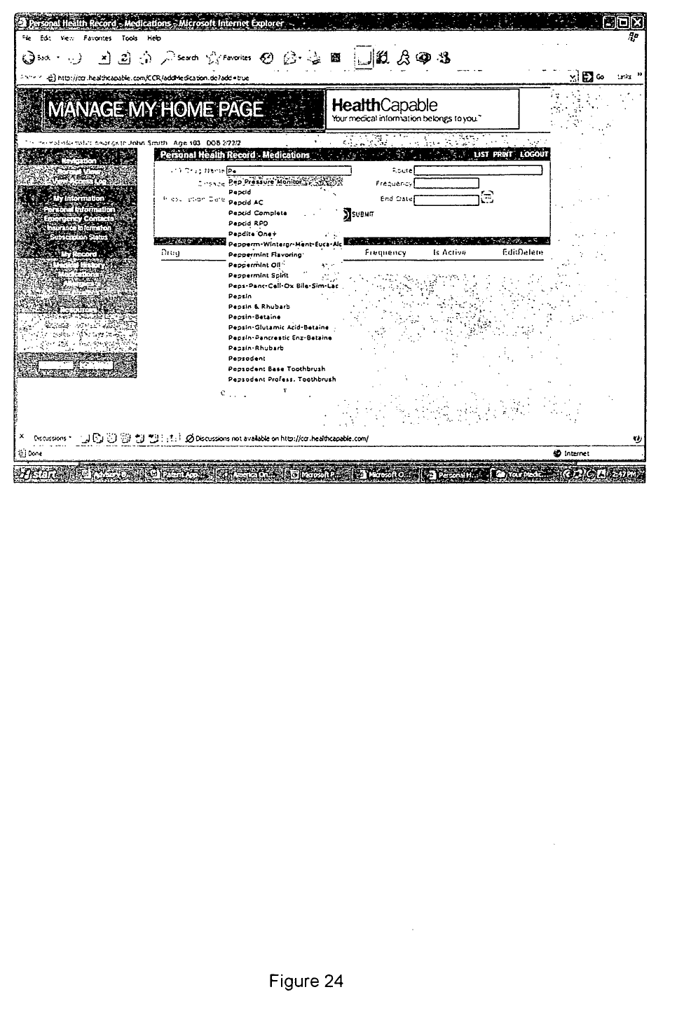

FIG. 24 also displays the static data set entries which a server side algorithm has determined to be relevant for display based on user input (in this case, the user has typed “Pe” in the text entry interface. Choices found in the static data set (or constrained vocabulary) are drugs and medical devices in this embodiment. The yellow background color of the text entry field shows that the server side algorithm is actively evaluating the user input, and that the user input does not currently match a predefined acceptable Drug Name entry.

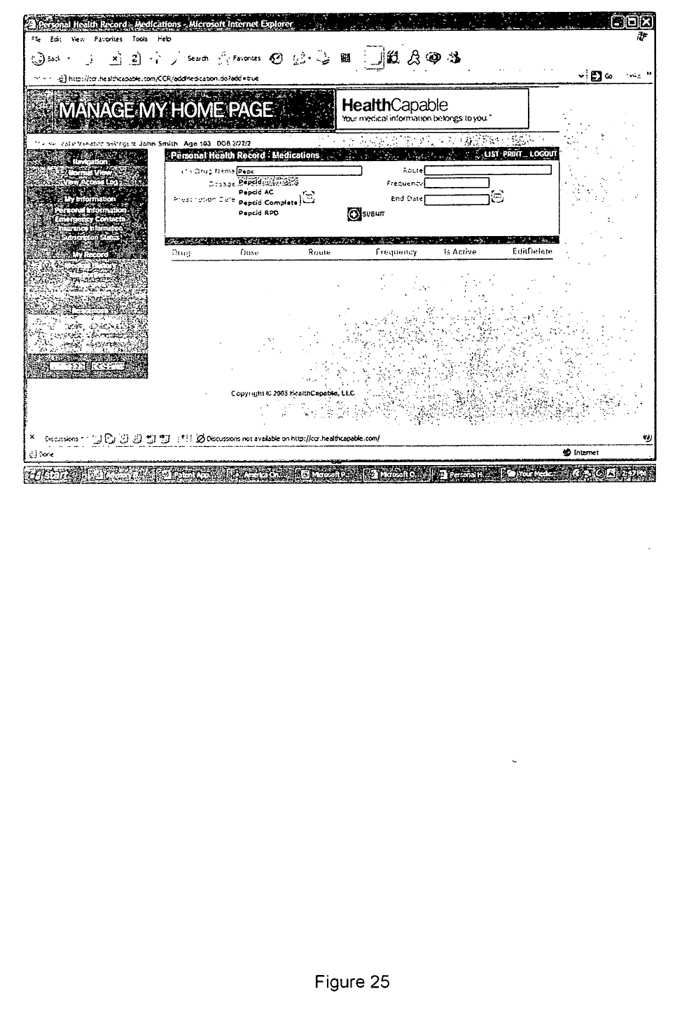

Further user input, now “Pepc” in the Drug Name text entry interface is illustrated in FIG. 25. The list of possible matches with this character sequence is now smaller, as displayed in the Static Data Set Display Area.

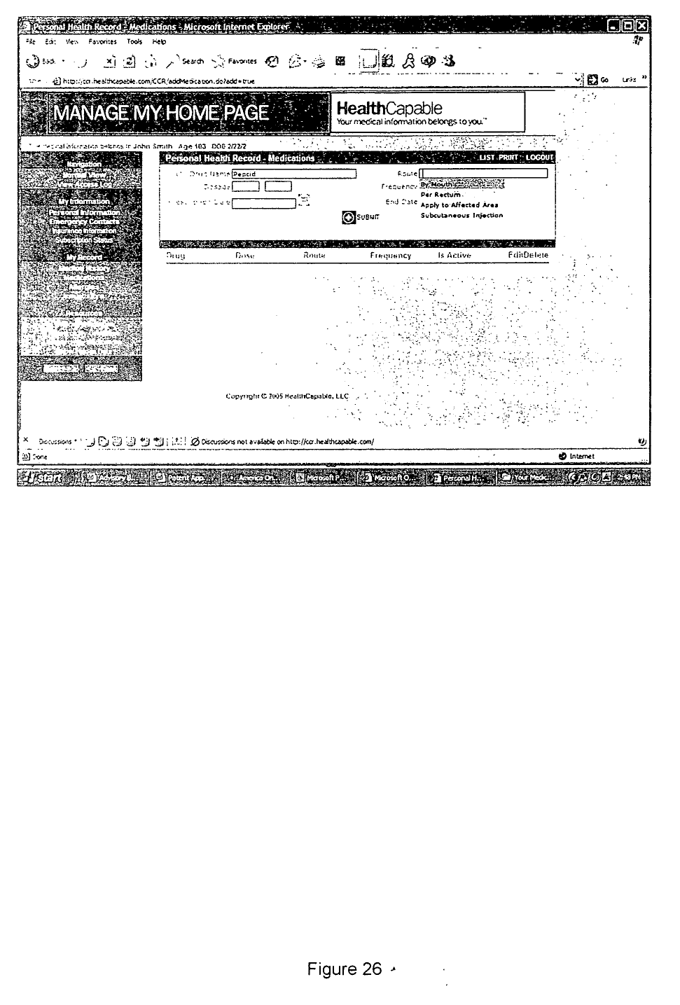

Continuing to represent the user interface in this sequence, FIG. 26 shows the appearance of the interface after the characters “Pepcid” have been entered in the Drug Name text entry interface (either by the user typing them, or by the user typing a partial character sequence and then selecting the complete character sequence from the list of possibilities displayed in the Static Data Set Display Area. The background of the Drug Name text entry interface is now blue, based on feedback from the server side algorithm that evaluates the contents of the Drug Name text entry interface; when the “Route” field gets focus (i.e. when the cursor is shifted to the “Route” text entry interface, the inventive system displays a pre-defined set of user choices for user selection. This list of pre-defined user choices can be independent or respective to earlier choices made by the user. For example, server side algorithms can be used to determine possible routes that are acceptable for a given drug choice previously made by the user.

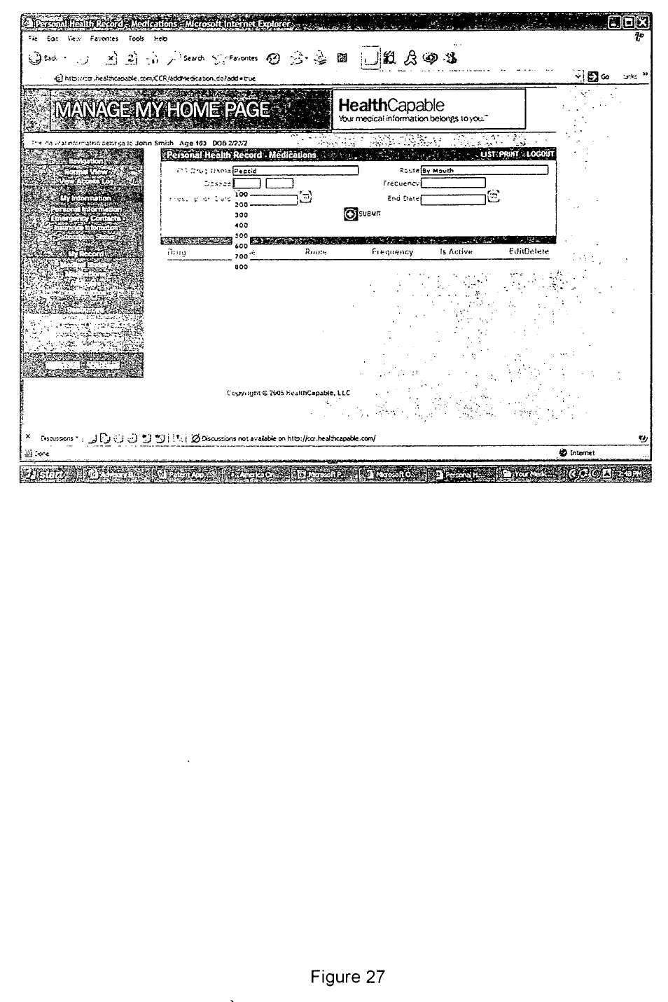

The continuation of this demonstration of this embodiment of the user interface according to the current invention is shown in FIG. 27. In this figure, the “Dosage” text entry interface displays possible dosage choices. In this illustration, possible dosages are shown that are not respective to the drug name chosen by the user; in another embodiment of the current invention the specific dose possibilities respective to the drug name selected by the user would be displayed.

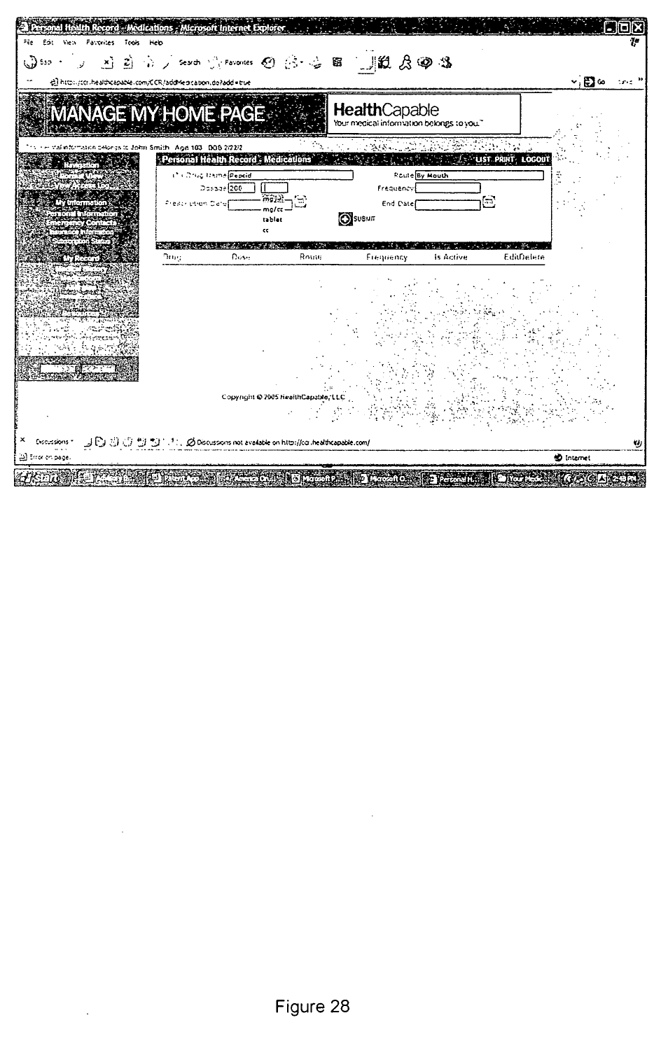

FIG. 28 is illustrative to the user interface which is displayed in the continuing sequence. The “Dosage Units” text entry receives focus (i.e. the cursor is placed there) and the static data set display area shows the acceptable possibilities for user selection.

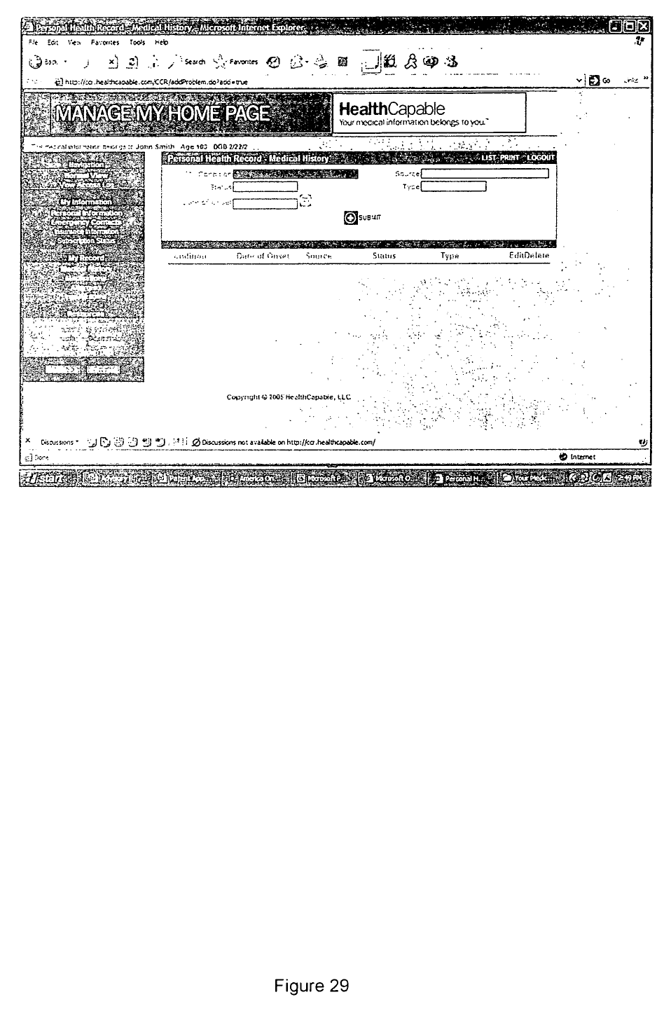

Another illustration of a preferred embodiment of the current invention is shown in FIG. 29. This is a user interface designed to force the user to enter a condition or disease name from a predefined list (rather than allowing free text entry). Again, the required field for proper system use, in this case the “Condition” text entry interface, has a red background at the first appearance.

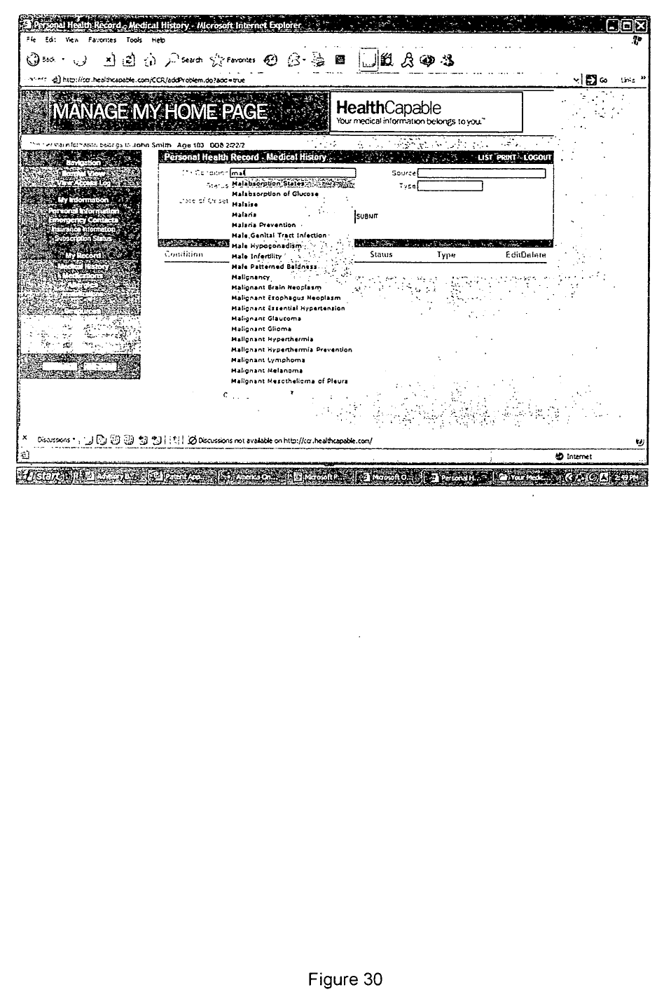

In this illustration of an embodiment of the inventive system, the user types “mal” in the Condition text entry interface shown in FIG. 30, and a static data set display area appears displaying possible matches contained within the predefined list of allowable entries that start with the same character sequence.

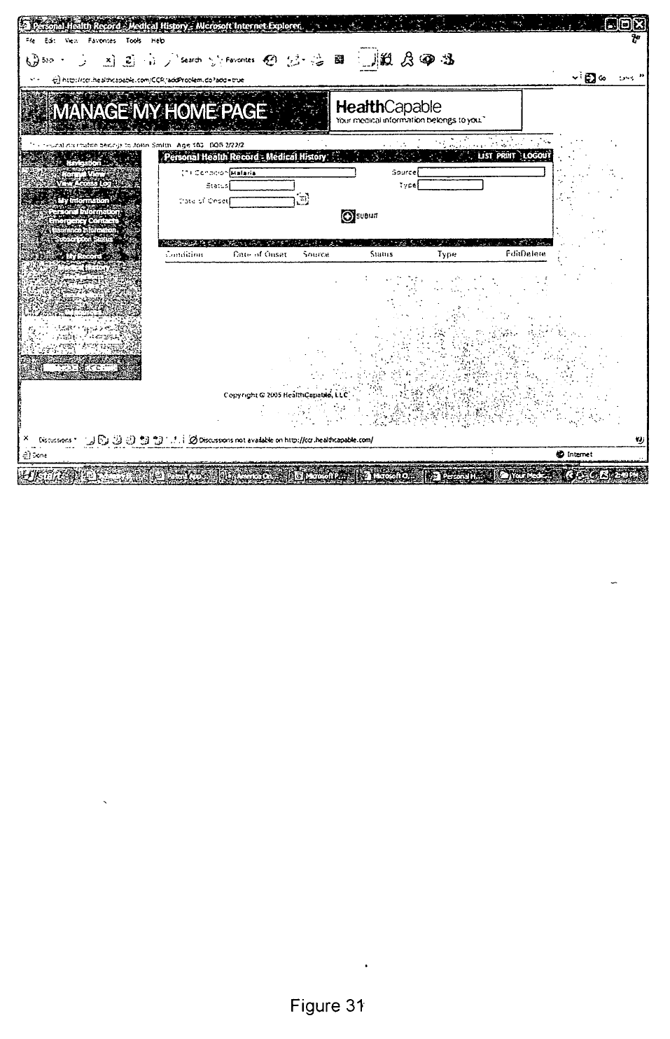

Continuing this sequence, in FIG. 31, if the user selected “Malaria” from the static data set display area, the character sequence (“Malaria”) is immediately displayed in the text entry interface, and the background color of the text entry interface changes to blue (to indicate a permissible data entry).

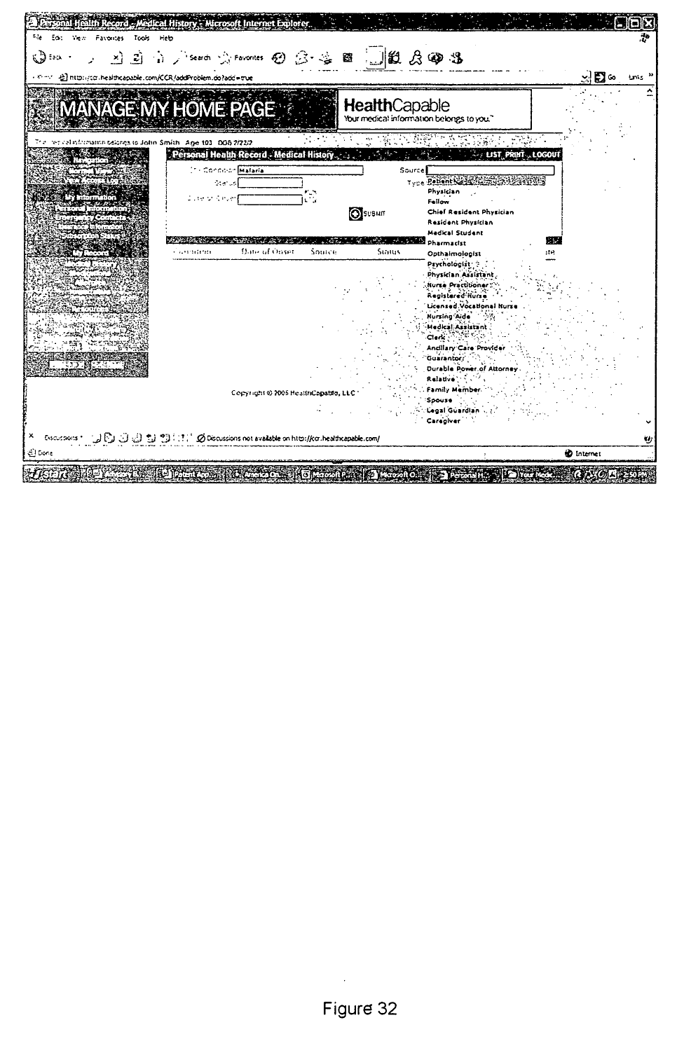

The same sequence continues in FIG. 32, where the allowed sources of information are displayed in the static data set display area at the moment that the “Source” text entry interface gets focus. The user can select by mouse click or pressing enter any of the highlighted choices, such selection causing the selected characters to appear in the “Source” text entry interface.

As a specific possible application of the current invention, a standardized vocabulary defining diagnoses is installed by the system administrator as the Static Data Set. The text interface area causes each keystroke entered by the user to be sent to the server. The server analyzes each keystroke and returns data (consisting of a subset of the Static Data Set) to the static data display area which is determined, via pre-defined rules defined by the system administrator, to likely be relevant to the user due to an association, or deduced association, with the specific set of characters already entered by the user into the text interface area. As a simplest example, the information shown in the static data display area could consist of all of the data contained within the Static Data Set that begins with the same sequence of characters as that currently contained within the text interface area.

The use of this system to control the flow of information between various data sources not related to healthcare is also anticipated and incorporated into this application by reference. Without doubt, many industries would benefit from “clean data,” that is, data that complies with a standardized vocabulary which allows for context-sensitive, perhaps interactive, systems.

The foregoing has outlined, in general and by example, the physical aspects of the invention and is to serve as an aid to better understanding the more complete detailed description. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention and within the scope of the claims and equivalents thereof.

What is claimed is:

1. A method of searching for pharmaceutical compounds for use in generating a prescription, comprising:
(a) display a text entry interface having a first field on a screen;
(b) receiving an input of a first character in the first field of the text entry interface;
(c) providing the first character to a remote server via a network;
(d) receiving a set of pharmaceutical compounds that are possible matches to the first character from the remote server in substantially real time;
(e) displaying at least a portion of the set of pharmaceutical compounds in a static data set display area on the screen;
(f) automatically updating the display of pharmaceutical compounds in response to an input of a second character, the updating being provided in substantially real time; and
(g) accepting a selection of one of the pharmaceutical compounds.

2. The method of claim 1, wherein the receiving in (b) is done via a wireless manner.

3. The method of claim 1, further comprising:
(h) displaying the selection of the one of the possible matches in the first field.

4. A computer-readable medium having computer-executable instructions for performing steps comprising:
(a) displaying a text entry interface on a screen;
(b) accepting a character input from a user;
(c) transmitting the symbol to a remote server via a network substantially simultaneously with displaying the symbol in the text entry interface on the screen;
(d) receiving a set of possible matches to the first symbol;
(e) displaying on the screen at least a first portion of the set of possible matches in a static data set display area;
(f) in response to an input of an additional character by the user, updating the display of the set of possible matches in substantially real time; and
(g) in response to a selection of one of the possible matches, displaying the selection in a first field.

5. The computer readable medium of claim 4, wherein the first field is part of the text entry interface and the displaying of the character in (c) comprises:
(i) displaying the character in the first field.
